(19) United States
(12) Patent Application Publication
(10) Pub. No.: US 2017/0020771 A1
(43) Pub. Date: Jan. 26, 2017

(54) INTERCHANGEABLE MASSAGE ROLLER SYSTEM

(71) Applicant: Eric Shannon, Boulder, CO (US)

(72) Inventor: Eric Shannon, Boulder, CO (US)

(21) Appl. No.: 15/286,404

(22) Filed: Oct. 5, 2016

Related U.S. Application Data
(63) Continuation-in-part of application No. 14/211,266, filed on Mar. 14, 2014.
(60) Provisional application No. 61/785,944, filed on Mar. 14, 2013.

(51) Int. Cl. A61H 15/00

(52) U.S. Cl. CPC A61H 15/00; A61H 2015/0014

(57) ABSTRACT

A massage roller system includes an axle and a massage roller rotatably mounted on the axle such that first and second ends of the axle protrude from first and second end surfaces of the massage roller. First and second handles are mounted to the first and second ends of the axle, each handle including a knob that, in response to twisting, adjusts pressure applied by the handle to one of the first and second end surfaces of the massage roller. First and second supportive plates each include a bearing surface for supporting the first and second handles.

### CROSS REFERENCE TO RELATED APPLICATIONS

This application is a continuation-in-part of and incorporates herein by reference in its entirety, NonProvisional application Ser. No. 14/211,266, pending, which claims the priority benefit of U.S. Provisional Application No. 61/785,944 which is also incorporated herein by reference in its entirety.

### BACKGROUND

This invention relates to self-massage, specifically to a deep tissue massage roller system that allows users to roll the body on a low-profile, customizable, free-spinning roller. This invention is particularly effective at relieving tender and painful connective tissue conditions such as tendinitis.

Although deep tissue massage has helped people for thousands of years to recover from injuries by stimulating the healing process, researchers are just now finding proof at the molecular level. Deep tissue massage, however, is expensive and not everyone can afford it or find the time for an appointment with a massage therapist.

As a result, many people do their own self massage at home. One popular method of doing one's own deep tissue massage is to use a roller made of foam or other harder material to apply pressure on the body. Rollers can be grouped into two categories.

First, there are rollers with handles which are used manually, relying on the force of one's hands and arms to perform a massage. Rice, in U.S. Pat. No. D648034 (2011) shows such a roller with handles. Second, there are gravity-type rollers which rely on the weight of one's body to apply pressure to the user's muscles and connective tissue. Of the rollers that rely on gravity, some have wheels, some are mounted on a frame and others have a much larger diameter in the 4 to 6 inch range, obviating the need for wheels or frame.

U.S. Pat. No. 7,223,251 to Phillips (2007) shows one example where smaller-diameter rollers are mounted on wheels. Both U.S. Pat. No. 3,759,250 to Salata (1973) and U.S. Pat. No. 4,688,556 to Keller (1987) show rollers held by a frame.

As compared to large-diameter foam rollers without wheels or handles, the smaller, low-lying rollers with wheels are particularly good for applying the strong pressure to the hamstrings, quadriceps, and calves needed to heal tendinitis and other conditions commonly experienced by athletes.

The rollers with wheels are also more effective than rollers with handles because they rely on gravity where the user sits or lies on top of the roller, thereby typically applying a greater force on the body with less effort.

However, these gravity-type massage rollers in their current configurations suffer from the following disadvantages:

(a) Those with wheels are limited in their use by the presence of the wheels which rise above the roller preventing the user from taking advantage of the full width of the roller—the wheels are a physical hindrance to the user.

(b) They force the user to travel across the floor requiring extra space and extra effort to perform the massage.

(c) They do not allow the user to change the height of the roller from the floor, nor the shape or hardness of the pressure surface. All the pressure dynamics are fixed, which forces the user to buy numerous rollers with different characteristics for use with different body parts.

No gravity-type massage roller offers the ability to perform massage using the full length of a single, low-lying, free-spinning roller, without interference from a base or wheels, while permitting easy adjustments to the height above the floor and to the shape and hardness of the roller surface. Furthermore, no gravity-type massage roller offers the ability to perform massage using a low profile free-spinning roller, while making height and horizontal angle adjustments and controlling the free spin tension.

### SUMMARY

Further, the disclosure also seeks to provide a massage roller system including an axle and a massage roller rotatably mounted on the axle such that first and second ends of the axle protrude from first and second end surfaces of the massage roller. First and second handles are mounted to the first and second ends of the axle, each handle including a knob that, in response to twisting, adjusts pressure applied by the handle to one of the first and second end surfaces of the massage roller. A first supportive plate includes a first surface and a second surface spaced apart from the first surface. A first bearing surface extends between the first and second surfaces and supports a first of the first and second handles. A second supportive plate includes a first surface and a second surface spaced apart from the first surface. A second bearing surface extends between the first and second surfaces and supports the second of the first and second handles.

The disclosure also seeks to provide a massage roller system including an axle and a massage roller rotatably mounted on the axle such that first and second ends of the axle protrude from first and second end surfaces of the massage roller. First and second handles are mounted to the first and second ends of the axle. A first supportive plate includes a first surface and a second surface spaced apart from the first surface. A first bearing surface extends between the first and second surfaces and supports a first of the first and second handles. A first bottom portion is provided between the first and second surfaces opposite the first bearing surface. The first bottom portion of the first supportive plate includes facets configured to mate with a first support surface. A second supportive plate includes a first surface and a second surface spaced apart from the first surface. A second bearing surface extends between the first and second surfaces and supports the second of the first and second handles. A second bottom portion is provided between the first and second surfaces opposite the second bearing surface. The second bottom portion of the second supportive plate includes facets configured to mate with a second support surface angled relative to the first support surface while the facets of the first bottom portion of the first supportive plate are mated with the first support surface.

The disclosure also seeks to provide a massage roller system including an axle, a massage roller rotatably mounted on the axle such that first and second ends of the axle protrude from first and second end surfaces of the massage roller. First and second handles are mounted to the first and second ends of the axle. A first supportive plate includes a first surface and a second surface spaced apart from the first surface. A first bearing surface extends between the first and second surfaces and supports a first of the first and second handles. A first bottom portion is provided between the first and second surfaces opposite the first bearing surface. The first supportive plate further includes a first arch extending towards the first bearing surface from the first bottom portion of the first supportive plate. A second supportive plate includes a first surface and a second surface spaced apart from the first surface. A second bearing surface extends between the first and second surfaces and support the second of the first and second handles. A second bottom portion is provided between the first and second surfaces opposite the second bearing surface. The second supportive plate further includes a second arch extending towards the second bearing surface from the second bottom portion of the second plate.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a perspective right side view of a massage roller system constructed in accordance with the invention;

FIG. 2 is a perspective right side view of the base of the massage roller system of FIG. 1;

FIG. 3 is a front view of the support base of the massage roller system of FIGS. 1;

FIG. 4 is a perspective right side view of the massage body assembly with the optional massage body sleeve of the massage roller system of FIG. 1;

FIG. 5 is a perspective right side view of the massage body of the massage roller system of FIG. 1;

FIG. 6 is perspective right side view of the massage body assembly of the massage roller system of FIG. 4 showing the assembly path for its parts;

FIG. 7 is a side view of the massage roller system of FIG. 1 showing a person using it to massage his back;

FIG. 8 is a perspective right side view of a preferred embodiment of two sleeve sets;

FIG. 9 is a perspective right side view of a preferred embodiment of two massage body sets without optional massage body sleeve;

FIG. 10 is a perspective right side view of a preferred embodiment of two support base sets;

FIG. 11 is a perspective right side view of a preferred embodiment of a retail system;

FIG. 12 is a perspective right side view of a preferred embodiment of a support base height adjustment method;

FIG. 13 is a side plan view of a snap-construction connection method for attaching the support base and the bolt shank axles of the massage roller system of FIG. 1;

FIG. 14 is a perspective right side view of another example massage roller system in accordance with the disclosure;

FIG. 15 is a perspective right side view of yet another example massage roller system in accordance with the disclosure;

FIG. 16 is a perspective right side view of yet another example massage roller system in accordance with the disclosure;

FIG. 17 is a perspective right side view of another example massage body assembly in accordance with the disclosure;

FIG. 18 is a perspective left view of an example handle assembly in accordance with the disclosure;

FIG. 19 is a perspective left broken view of one end of an example axle in accordance with the disclosure;

FIG. 20 is a perspective left view of still another example massage roller system in accordance with the disclosure;

FIG. 21 is a perspective right view of an example support base usable as part of disclosed massage roller systems;

FIG. 22 is a front view of an example massage roller system in accordance with the disclosure having one end propped on a cylindrical object;

FIG. 23 is a perspective right view of another example support base usable as part of the disclosed massage roller systems.

FIG. 24 is a front view of the example support base of FIG. 23.

FIG. 25 is a front view of another example massage roller system in accordance with the disclosure having one end propped on a cylindrical object;

FIG. 26 is an end view of an example massage roller system in accordance with the disclosure having one end propped against a wall;

FIG. 27 is a perspective right view of another example support base usable as part of disclosed massage roller systems;

FIG. 28 is a perspective right view of another example support base 240 usable as part of disclosed massage roller systems; and

FIG. 29 is a perspective right view of another example support base 240 usable as part of disclosed massage roller systems.

### REFERENCE NUMERALS

1 massage roller system

2 massage body assembly

3 massage body sleeve

4 massage body

5 rolling element bearings

6 support base

7 bolt

7a bolt head

7b bolt threads

7c bolt shank

8 bolt head recess

9 bolt shank cutout

10 bolt shank support

11 rolling element bearing recess

12 massage body bore

13 bolt coupling

20 person

21 person's back

22 floor

30 long sleeve set

31 short sleeve set

32 long hourglass-shaped sleeve

33 long thin sleeve

34 long thick sleeve

35 short thin sleeve

36 short thick sleeve

40 long massage body assembly set

41 short massage body assembly set

42 long hourglass-shaped massage body assembly

43 long small-diameter massage body assembly

44 long large-diameter massage body assembly

45 short small-diameter massage body assembly

46 short large-diameter massage body assembly

50 long support base set

51 short support base set

53 long high support base

54 short low support base

55 short high support base

60 prepackaged massage roller system sets

61 prepackaged massage body assembly sets

62 prepackaged massage body sleeve sets

63 prepackaged support base sets

64 massage body assemblies sold individually

65 massage body sleeves sold individually

66 support bases sold individually

70 support base height extension part

80 snap-construction bump

D1 forward direction of movement

D2 backward direction of movement

140 massage roller system

141l first supportive plate

141r second supportive plate

142l first left foot

142r first right foot

143l second left foot

144l first handle

145l first knob

145r second knob

146 massage roller

147l first end surface

150 massage roller system

151l first supportive plate

151r second supportive plate

152l first left foot

152r first right foot

153l second left foot

153r second right foot

154l first handle

154r second handle

155l first knob

155r second knob

156 massage roller

157l first end surface

160 massage roller system

161l first supportive plate

161r second supportive plate

1621 first left foot

162r first right foot

163l second left foot

164l first handle

164r second handle

165 handle

165l first knob

165r second knob

166 massage roller

167l first end surface

164 handle

164a handle notch

164b handle end surface

164c handle lumen

168 axle

168a axle facet

168b axle threads

169 directional arrow

200 massage roller system

201 supportive plate

201l first supportive plate

201r second supportive plate

202l first left foot

202r first right foot

203r second right foot

204l first arch

204r second arch

205l first knob

205r second knob

206l first handle

206r second handle

207 massage roller

208r first end surface

210 support base

211 supportive plate

211a first surface

212 first foot

213 second foot

214 arch

215 bearing surface

220 cylindrical object

230 support base

231 first supportive plate

231a first surface

231b second surface

232 first foot

232a first inferior arch

233 second foot

233a second inferior arch

234 superior arch

235 bearing surface

236 massage roller

250 cylindrical object

261 first support surface

262 second support surface

263 third support surface

270 support base

271 supportive plate

271a first surface

272 first foot

272a first facets

273 second foot

273a second facets

274 arch

275 bearing surface

280 support base

281 supportive plate

281a first surface

281b second surface

281c front surface

282a third facet

283a first facet

285 bearing surface

290 support base

291 supportive plate

291a first surface

291b second surface

291c front surface

292a first rounded edge

293a second rounded edge

### DETAILED DESCRIPTION

The following detailed description illustrates embodiments of the present disclosure and manners by which they can be implemented. Although the best mode of carrying out the present disclosure has been disclosed, those skilled in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

The invention, a single, free-spinning roller sitting on an interchangeable, low-profile support base, allows a user to roll the body across the full breadth of the roller without any interference from the base. The interchangeable massage roller system also allows easy changes to the hardness and surface shape of the roller using interchangeable sleeves. Varying the sleeve shape, thickness and density allows the user to change the pressure applied taking into consideration the part of the body part being massaged. The user may also swap support bases to adjust the roller system's height above the floor. More advantages will become apparent from a study of the following description and accompanying drawings.

Embodiments of the present disclosure provide systems for performing massage using the full length of a single, low-lying, free-spinning roller, without interference from a base or wheels, while permitting adjustments to the height above the floor and to the shape and hardness of the roller surface.

Embodiments of the present disclosure substantially eliminate, or at least partially address, problems in the prior art.

Additional aspects, advantages, features and objects of the present disclosure will be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

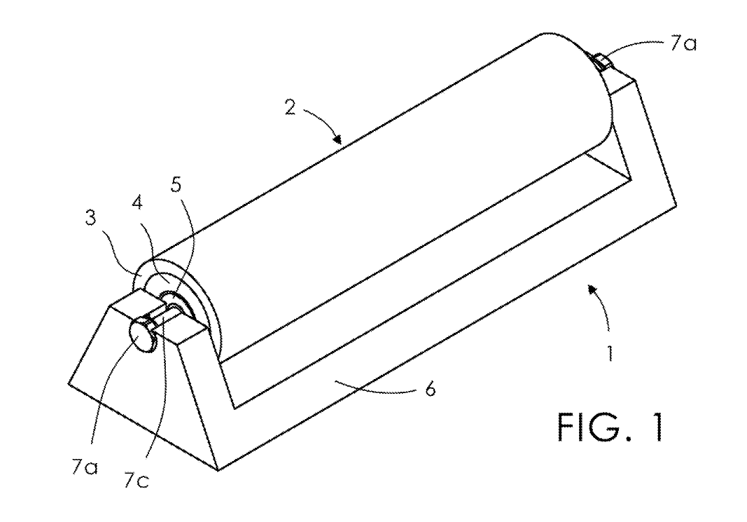

FIG. 1 is a perspective right side view of a massage roller system 1 constructed in accordance with the invention. The support base 6 provides support for the massage body assembly 2 which is suspended across the span of the support base 6 by bolt shanks 7c which act as axles. Bolt heads 7a are embedded in a recess in the support base 6 so they do not protrude more than a millimeter or two beyond the edge of the support base 6.

The massage body 4 has two rolling element bearing sets 5 where one set is recessed at either end (typically type 608 in-line skate bearings) and thus rotates freely and easily. Massage roller system 1 may be used with or without the optional massage body sleeve 3 according to the user's preference for massage hardness and pressure. The massage body 4 typically has a diameter of between about 2.54 cm and 20.32 cm, and is rigid.

However, massage body 4 may also have the function of the massage body sleeve 3 incorporated into the massage body itself, in which case, it may have a variable outside shape and outer Shore C hardness of between about 10 and 100, while the inner core remains rigid.

Massage body sleeve 3 may be any soft material such as EVA, rubber, foam or neoprene and may vary in thickness also according to the user's preference. The sleeve will generally have a Shore C hardness of between about 10 and 70, a thickness of between about 0.635 cm and 8.89 cm and an inner sleeve diameter of between about 2.54 cm and 10.16 cm. It will always have a hardness lesser than the massage body because its function is to cushion the rigid massage body 4.

The massage body assembly 2 is held in place in the support base 6 by gravity or snap connection so the user may lift the massage body assembly 2 up out of the support base 6 at any time to change the massage body sleeve 3.

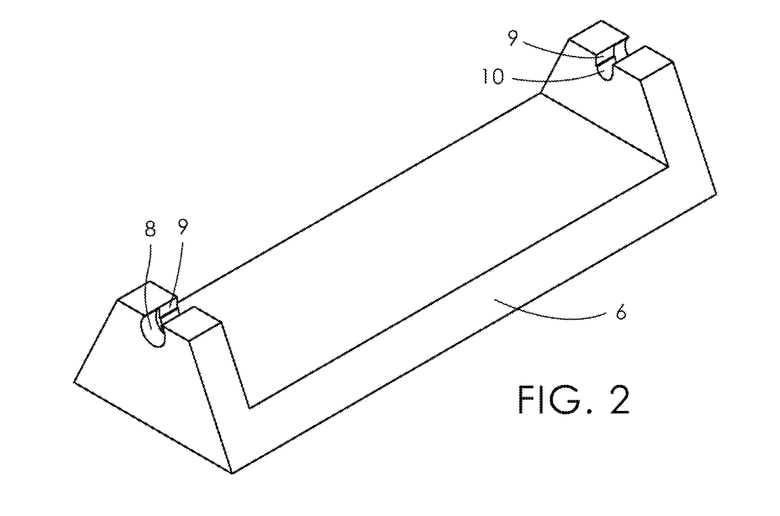

FIG. 2 is a perspective right side view of the support base 6 of the massage roller system of FIG. 1 showing the base alone without a massage body assembly.

The base is typically constructed of a rigid plastic, nylon or similar material. It is typically approximately 1 to 1.5 cm thick, 5 cm tall, 8.5 cm wide and 26 cm long. Bolt shanks supports 10 typically have a radius of 4 mm to perfectly accommodate 8 mm bolt shanks. The bolt shank cutout 9 is generally a little wider than the bolt shank, typically 9 mm wide to allow an 8 mm bolt to travel freely up-and down. Bolt head recess 8 typically has a 13 mm diameter and allows the bolt head to fit snugly without protruding more than 1 to 2 mm beyond the edge of support base 6.

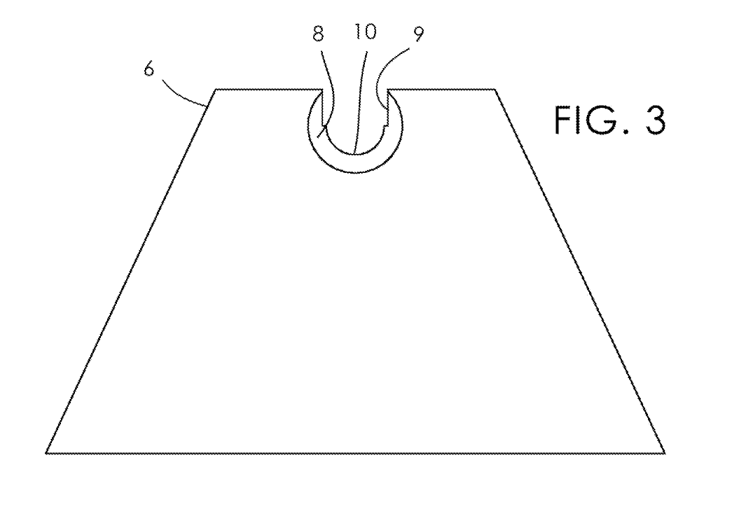

FIG. 3 is a side view of the support base 6 of FIG. 2 showing bolt shank support 10, bolt shank cutout 9 and bolt head recess 8 in profile. This figure shows a loose-fitting connection type that functions without any fastener and is designed to receive the massage body axles (bolt shanks 7c) and hold them in place using fit and gravity alone. This allows the user to detach the parts very easily and quickly.

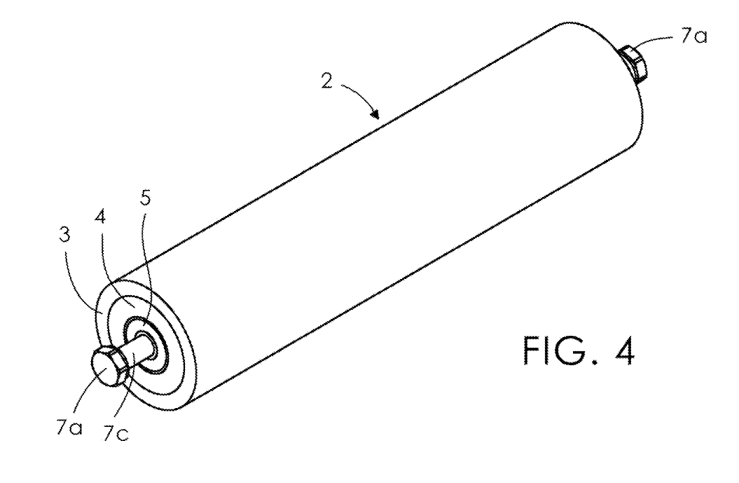

FIG. 4 is a perspective right side view of the massage body assembly 2 of massage roller system 1 of FIG. 1 showing the assembled roller with optional massage body sleeve 3 in place. The massage body sleeve will vary in thickness and may be constructed of rubber, foam, neoprene or any similar material. The surface of the sleeve in this drawing is shown flat and smooth, but it may also be constructed with bumps and rounded protrusions or a larger wavelike shape, for example, so that the massage body assembly appears to have an hourglass shape. Note massage body 4 is contained inside massage body sleeve 3 and shows bolt shank 7c protruding through rolling element bearings 5. Bolt head 7a is attached to bolt shank 7c which has a diameter of between about 0.635 cm and 0.952 cm.

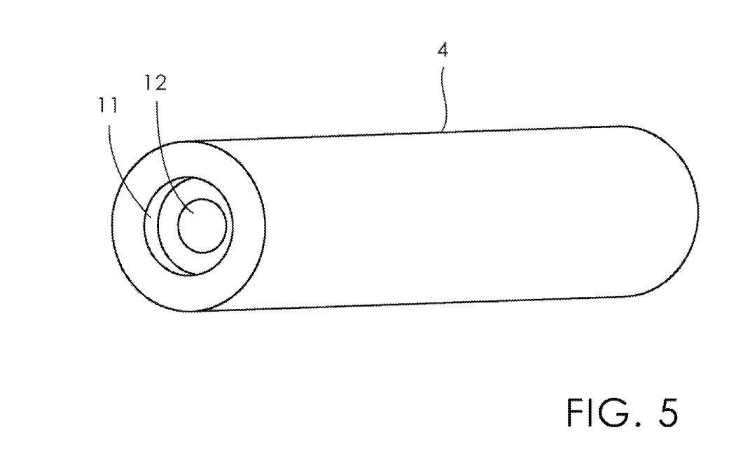

FIG. 5 is a perspective right side view of the massage body 4 of massage body assembly 2 of FIG. 4. It is typically constructed of a rigid plastic or nylon or similar material and typically about 22 cm long with a diameter of about 38 mm. The inside diameter of the massage body is the diameter of the massage body bore 12 and is about 12 mm to accommodate the height of the bolt coupler hardware. The rolling element bearing recess 11 at each end of the massage body is dimensioned to accommodate the rolling element bearings 5 which are typically 608 in-line skate bearings with an outside diameter of 22 mm and a depth of 7 mm.

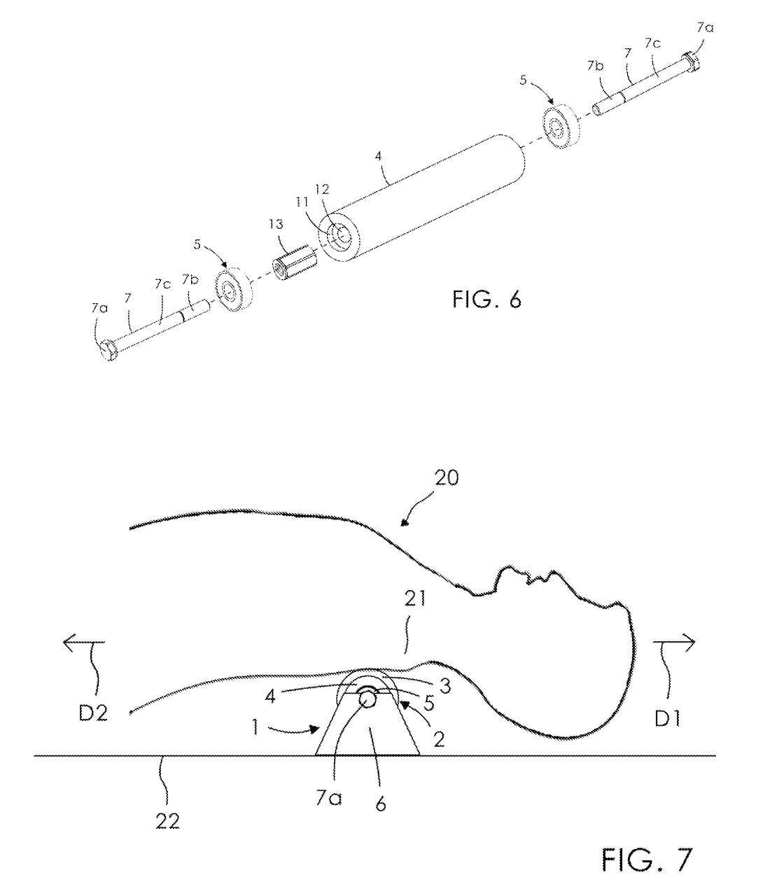

FIG. 6 is perspective right side view of the massage body assembly 2 (without the optional massage body sleeve 3) of the massage roller system of FIG. 4 showing the assembly path for all its parts. Shown on the outsides are two bolts 7 having bolt heads 7a, bolt shanks 7c, and bolt threads 7b. Next, moving inward are the two rolling element bearings 5 and on the left side of the drawing the coupler 13 which connects the two bolts 7 in the middle of the massage body 4. Finally, in the middle, massage body 4 shows rolling element bearing recess 11 and massage body bore 12.

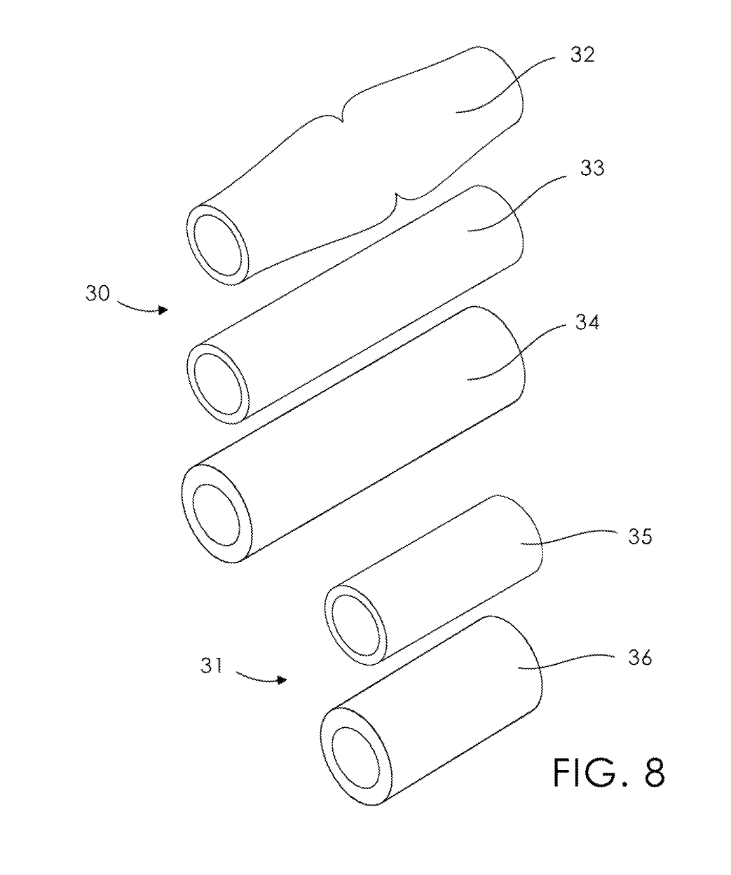

FIG. 7 is a side view of the massage roller system 1 of FIG. 1 showing a person 20 using it on the floor 22 to massage his back 21. Person 20 will move backwards and forwards on the massage body sleeve 3 following the direction of movement arrows D1 and D2 taking care not to roll directly on the spine (person 20 will be massaging one side of his back at a time, rolled slightly onto his side). The massage body 4 is shown inside the massage body sleeve 3, as is rolling element bearing 5 and bolt head 7a. The massage body assembly is supported by support base 6 resting on floor 22.

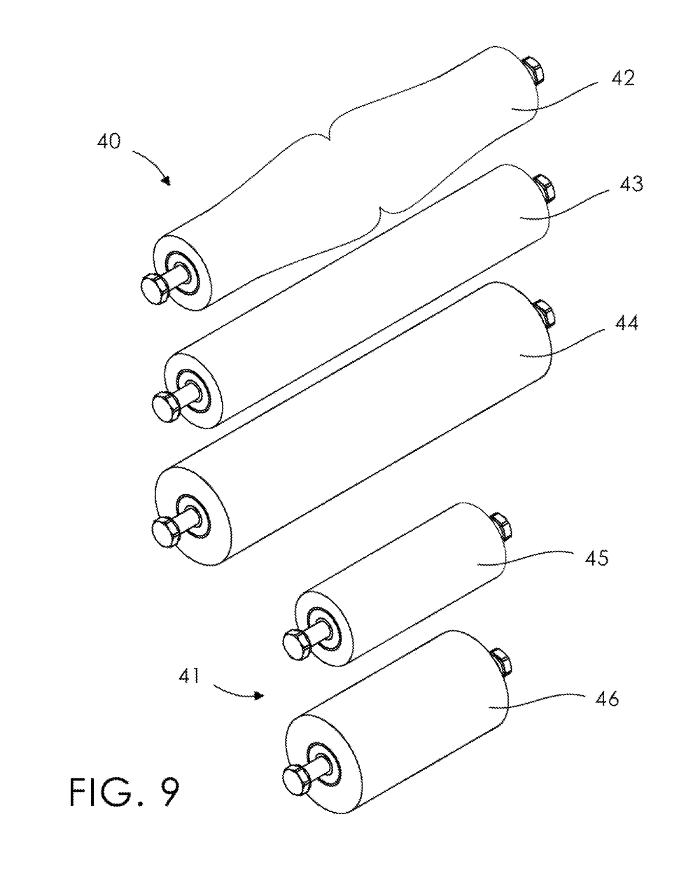

FIG. 8 is a preferred embodiment of several sleeve sets. First sleeve set 30, and second sleeve set 31 contain two distinct types of sleeves. As seen here, each of the two sets have different widths matching the massage body widths shown in FIG. 9. Sleeve 32 fits the long massage body 43 shown in FIG. 9 and has an hourglass shape useful for massaging the back, calves, hamstrings and quadriceps. Sleeve 33 fits the long massage body 43 shown in FIG. 9 and is very thin allowing for strong massage pressure while sleeve 34 also fits the long massage body 43 shown in FIG. 9 but is thicker providing a gentler massage pressure.

Sleeve 35 fits the short massage body 45 shown in FIG. 9 and is thin for strong massage pressure while sleeve 36 also fits the short massage body 45 shown in FIG. 9 but provides more cushioning for a softer massage.

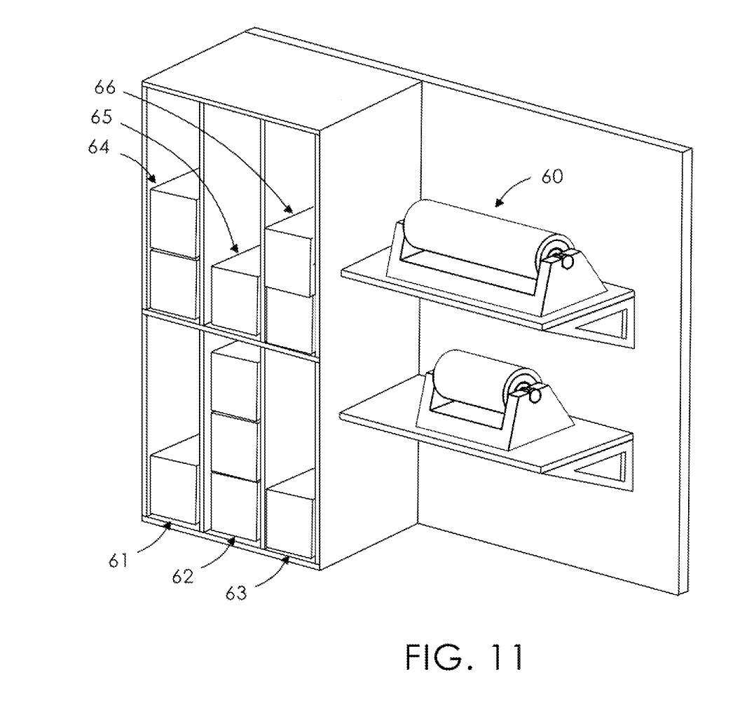

In addition to differences in the size and shapes, sleeves may also differ in material composition and surface texture. Although only two sleeve sets are shown here, massage roller system 1 may contain any number of sleeves sets containing any number of sleeves. In some situations, it may be preferable for a user to purchase prepackaged sets. Using a retail system, like that shown in FIG. 11, the user could purchase individual sleeves separately or in prepackaged sets.

It should be noted that the use of the sleeve is optional. The interchangeable massage roller system may be used without sleeve for maximum massage pressure.

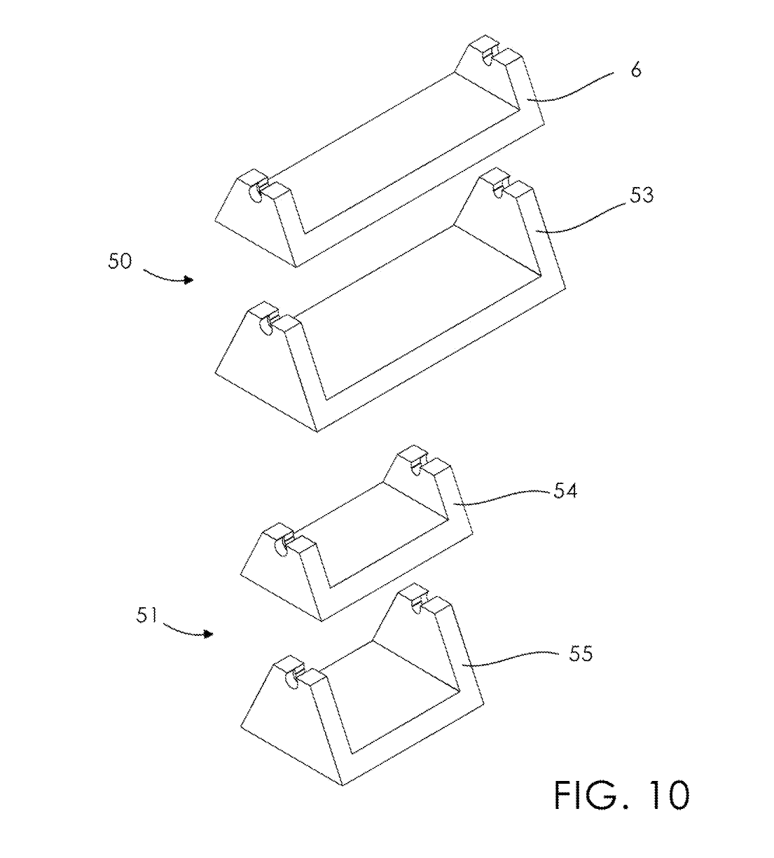

FIG. 9 is a preferred embodiment of several massage body assembly sets (without optional massage body sleeve 3). First massage body assembly set 40, and second massage body assembly set 41 contain two distinct types of massage bodies. Long massage body assembly set 40 fits the long support base set 50 shown in FIG. 10 and short massage body assembly set 41 fits the short support base set 51 shown in FIG. 10. Massage body assembly 42 has an hourglass shape useful for massaging the back, calves, shins, quadriceps, and hamstrings. Massage body assembly 43 has a small diameter useful for providing strong massage pressure. Massage body assembly 44 has a larger diameter than 42 or 43 providing a gentler massage and can be more suitable for the back and IT band.

Massage body assembly 45 has a narrow diameter like massage body assembly 43 but fits the short support base set 51 shown in FIG. 10. Massage body assembly 46 also fits short support base set 51 shown in FIG. 10, but has a larger diameter for a gentler massage. Both massage body assemblies 45 and 46 are more useful for massaging the legs because of their narrow width and may be preferred where space is limited or the need to travel with them arises.

In addition to differences in the size and shapes, massage body assemblies may also differ in material composition and surface texture. Although only two sets are shown here, massage roller system 1 may contain any number of massage body assembly sets containing any number of massage body assemblies. In some situations, it may be preferable for a user to purchase prepackaged sets. Using a retail system, like that shown in FIG. 11, the user could purchase individual massage body assemblies separately or in prepackaged sets.

FIG. 10 is a preferred embodiment of several support base sets. First support base set 50, and second support base set 51 contain two distinct types of support bases. First long support base set 50 contains support bases fitting the long massage bodies of massage body set 40 of FIG. 9. Second support base set 51 contains support bases fitting the short massage bodies of massage body set 41 of FIG. 9.

Support base 6 is long and low and may be ideal for performing back massage and working the gluteals or IT band. Long high support base 53 is just as wide as support base 6 but higher and consequently may be more useful for working the forearms, triceps, calves and shins.

Short low support base 54 is short and low and may be useful for working the IT band and hamstrings where space is limited or travel necessary. Short high support base 55 is short and higher and may be ideal for working the shins and calves where space is limited or travel is required.

FIG. 11 shows a preferred embodiment of a retail system, in which prepackaged massage roller system sets 60 are sold simultaneously with prepackaged sets of massage body assemblies 61, prepackaged massage body sleeve sets 62, prepackaged support base sets 63 individual massage body assemblies 64, individual massage body sleeves 65, and individual support bases 66. In this embodiment, the retail system is a section of the wall. In a preferred embodiment, this wall would be a portion of a retail store. In some embodiments, the prepackaged massage roller system sets 60 may be different styles and colors.

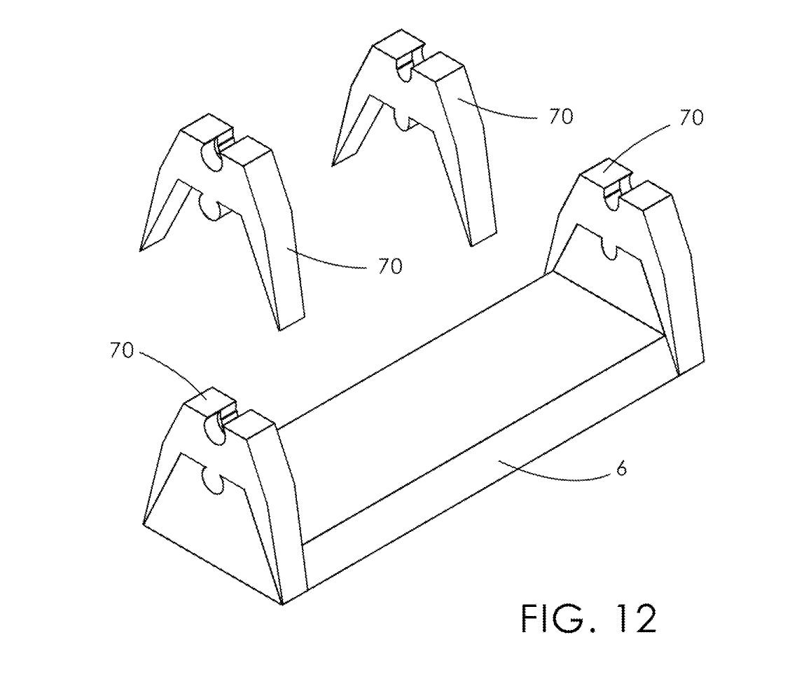

FIG. 12 shows a preferred embodiment of a support base height adjustment method. Two support base height extension parts 70 are shown before and after connecting to support base 6. The support base height extension part 70 is keyed to slide onto support base 6 and fits together like a puzzle relying on friction to keep the parts together. The top surface of the support base height extension part is identical to the top of the support base 6 which it covers up. This allows the user to make small adjustments in the height of the massage roller system to accommodate individual differences and preferences.

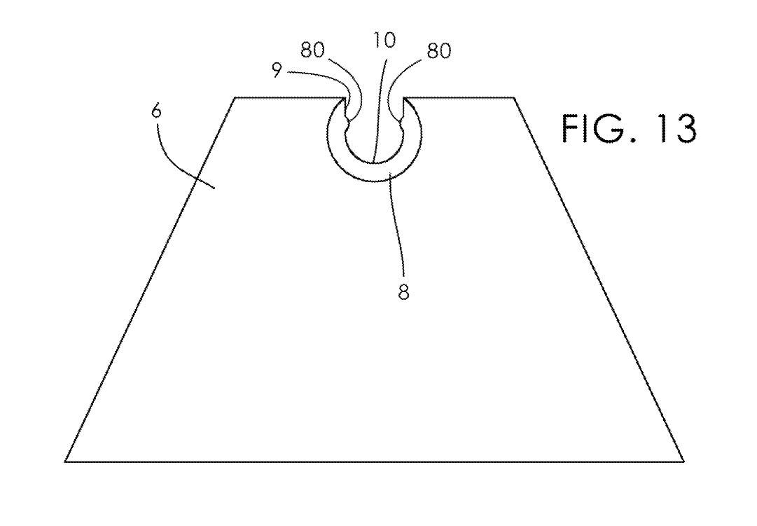

FIG. 13 is a side plan view of a preferred embodiment of a snap-construction connection method for attaching the support base 6 and the bolt shank 7c (axle) of the massage roller system of FIG. 1. This is a connection method for obtaining a tight-fitting, fixed but detachable connection between the support base 6 and the massage body 4 of FIG. 1. This is in contrast to the loose-fitting, easy-release, connection type shown in FIG. 3.

The bolt head recess 8 and bolt shank support 10 shown here are identical to the bolt head recess 8 and bolt shank support 10 shown in FIG. 3. The bolt shank cutout 9 however, is narrower here, so that the width of the cutout perfectly matches the diameter of the bolt shank 7c of FIG. 1. The more critical difference shown here, is the presence of snap-construction bumps 80, which have a depth of about 1 mm, and hold the bolt shank firmly in place after it is snapped down against bolt shank support 10.

### Operation-FIGS. 1-7

In typical application the massage roller system 1 can be used to relieve pain and discomfort associated with muscular and other connective tissue ailments such as repetitive stress injuries of all types including carpel tunnel syndrome, tennis elbow or plantar fasciitis, for example.

First, the user 20 may purchase a prepackaged roller massage system 60 from a retailer incorporating a variety of support bases 6, massage body assemblies 4 and massage body sleeves 3 so that he may assemble a roller massage system ideal for treating a specific injury. The user 20 may interchange the parts of the roller massage system as often as necessary according to the body part being treated.

The user 20 may also wish to purchase the roller massage system components individually, too, based on his specific immediate needs. After purchasing the roller massage system, if it is not already assembled, the user will select a massage body sleeve 3 and select a massage body assembly 4 that fits and slide them together (if he desires to cushion the massage body 4 or desires to change the shape of the massage surface). Next, the user fits the massage body axles 7c onto the support base 6 and connects the two. This may require pushing together until a snap is heard.

In the event that a muscle in the back of a user 20 (FIG. 7) is afflicted with pain or discomfort caused by stress and/or muscle spasm, for example, the user 20 places the massage roller system 1 on the floor 22. The user 20 then lies down on the floor and device 1 so that the massage roller system sits underneath the afflicted muscle or tendon and rolls slowly backwards and forwards as indicated by the arrows, using the feet and/or hands and arms to push the body. Note that user 20 must take care not to roll directly on the spine and to avoid doing so, will rotate his body slightly either to the left or the right depending on where the affliction is.

As the weight of the back 21 is applied against the massage body sleeve 3 or optionally on massage body 4 without the sleeve, the muscles and tendons of the back flex and conform temporarily around the shape of the massage body. The massage roller, in effect, is applying pressure, just as a human massage therapist would, which penetrates the belly of the muscle without damaging it. This pressure restores elasticity thus promoting healing and relief of pain and discomfort.

Optimal use of massage roller system 1 requires the user apply steady and continuous pressure in each afflicted area and surrounding areas for 15 to 60 seconds before rolling backwards or forwards.

This procedure is repeated as often as is necessary to relieve an affliction and eliminate the condition. This is usually at least once daily for 7 to 30 days but it will be appreciated by those skilled in the art that repeated use of the massage roller system 1 in the manner heretofore described is also effective in preventing additional occurrences of the pain or discomfort. Massage roller system 1 provides a safe and effective way for a person to manipulate muscle and connective tissue on his or her own, without the aid of a massage therapist.

Because massage roller system 1 has interchangeable parts, the user may swap out the massage body sleeve 3 to change the softness of the massage delivered by the massage body 4. As the muscles and connective tissue begin to heal and become less sensitive, a denser harder massage surface will maximize the effectiveness of the massage treatment and eventually the user may find it most effective to use the massage body without any sleeve.

The user may also swap out the support base 6 for a taller one which may be useful for massaging the shins or calves.

It will be appreciated by those skilled in the art that massage roller system 1 may be used to massage almost any part of the body in a substantially hands-free way, including but not limited to the back, abdomen, legs, arms or feet, in the manner heretofore described.

For example, in an alternative manner of use, the device may be placed on a table to more easily massage both forearms by leaning forward on top of the device with the elbows extended. To massage the feet, the user 20 would place the massage roller system 1 on the floor and stand up, placing one foot on top of the massage body assembly 2, applying pressure downward on the device.

### Advantages

From the description above, a number of advantages of my interchangeable massage roller system become evident:

(a) Because the low-profile base is lower than the roller, the user may lie on top of the roller without touching the base and without experiencing any interference from it. This allows the user to benefit from the full length of the roller during massage.

(b) By selecting an appropriate sleeve thickness and shape, the user may find just the right degree of pressure and depth of penetration for each body part or injury.

(c) By selecting an appropriate support base height, the user can place the roller at just the right height for a body part for a more efficient massage.

(d) The use of a free-spinning roller saves space by preventing the user from rolling across the floor.

(e) The free spinning roller saves energy by preventing the user from pushing his way large distances across the floor and is consequently more relaxing to use.

### Conclusion, Ramifications, and Scope

Accordingly, the reader will see that the ability to customize the characteristics of a single, free-spinning massage roller with a low-profile base has additional advantages in that:
the ability to apply the right amount of pressure in the right place without interference from the rolling mechanism or base, and with minimal effort, makes this device more efficient than other designs;
it can be used to perform a highly individualized deep tissue massage according to the circumstantial needs of the user and specific body part being worked on;
its great versatility allows the user to perform effective deep tissue massage on a wide variety of body parts including the feet, calves, shins, hamstrings, quadriceps, hips, abdominals, mid, lower and upper back, forearms and triceps.

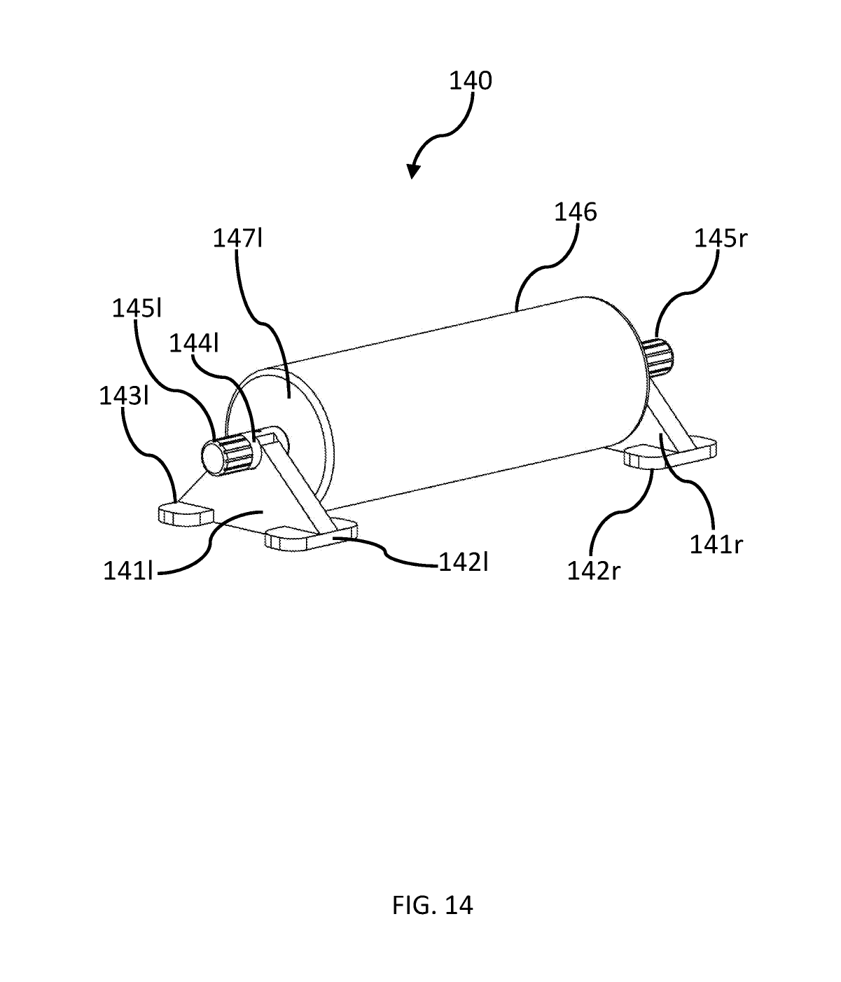

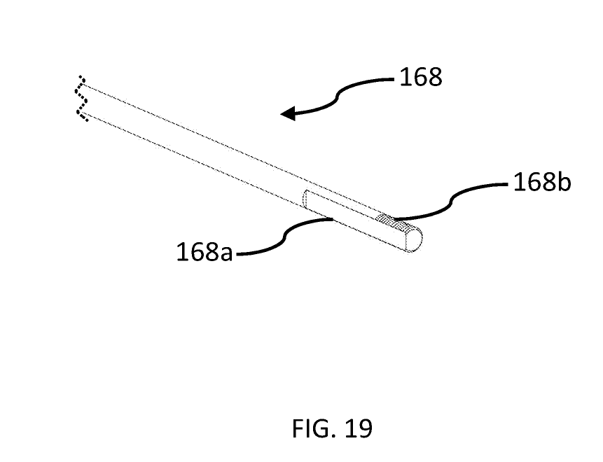

FIG. 14 is a perspective right side view of another example massage roller system 140 in accordance with the disclosure. Massage system 140 includes an axle 168 described in detail with reference to FIG. 19, a massage body assembly or massage roller 146 rotatably mounted on axle 168 such that first and second ends of the axle protrude from first 147l and second (not visible) end surfaces of massage roller 146. First 144l and second (not visible) handles mounted to the first and second ends of the axle (not visible). Handle 144l includes a knob 145l and handle 144r includes a knob 145r. In response to twisting of knob 145l, 145r or both, pressure applied by the handle 145l or 145r to one of the first end surface 147l, the second end surface or both of the massage roller 146 is adjusted.

A first support base in the form of a first supportive plate 141l supports a first end of massage roller 146 at handle 144l and a second support base in the form of a second supportive plate 141r supports a second end of massage roller 146 at a handle not visible behind massage roller 146. A bottom portion of supportive plate 141l includes feet 142l and 143l to stablize supportive plate 141l while a bottom portion of supportive plate 141r includes a first foot 142r and a second foot (not visible) to stabilize supportive plate 141r.

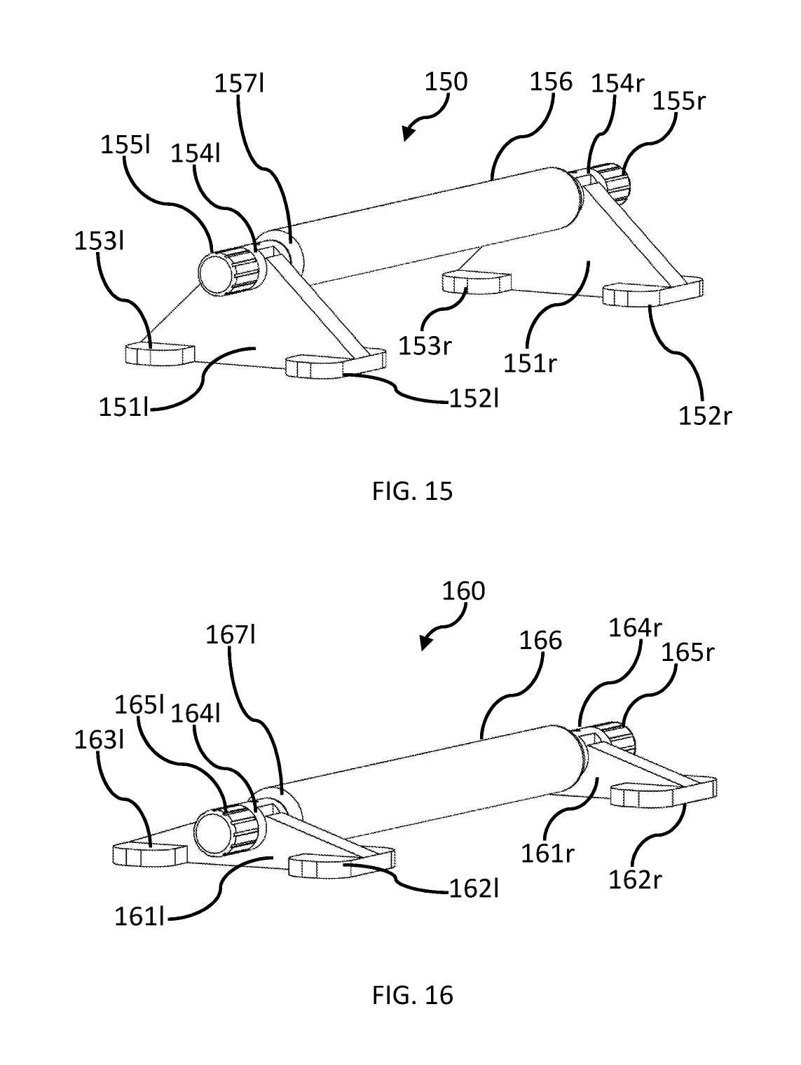

FIG. 15 is a perspective right side view of yet another example massage roller system 150 in accordance with the disclosure. Massage system 150 includes an axle 168 (FIG. 19), a massage body assembly or massage roller 156 rotatably mounted on axle 168 such that first and second ends of the axle protrude from first 157l and second (not visible) end surfaces of massage roller 156. First 154l and second 154r handles mounted to the first and second ends of the axle (not visible).

Each handle 154l and 154r includes a knob 155l and 155r that, in response to twisting, adjusts pressure applied by the handle 154l or 154r to one of the first 157l and second end (not visible) surfaces of the massage roller 156.

A first support base in the form of a first supportive plate 151l supports a first end of massage roller 156 at handle 154l and a second support base in the form of a second supportive plate 151r supports a second end of massage roller 146 at a handle 154r. A bottom portion of supportive plate 151l includes feet 152l and 153l to stablize supportive plate 151l while a bottom portion of supportive plate 151r includes a first foot 152r and a second foot 153r to stabilize supportive plate 151r.

As shown by way of example in FIG. 15, massage roller 156 may have a small diameter relative to the height of supportive plates 151l and 151r.

FIG. 16 is a perspective right side view of yet another example massage roller system 160 in accordance with the disclosure. Massage system 160 includes an axle 168 (FIG. 19), a massage body assembly or massage roller 166 rotatably mounted on axle 168 such that first and second ends of the axle protrude from first 167l and second (not visible) end surfaces of massage roller 166. First 164l and second 164r handles mounted to the first and second ends of the axle (not visible).

Each handle 164l and 164r includes a knob 165l and 165r that, in response to twisting, adjusts pressure applied by the handle 164l or 164r to one of the first 167l and second end surfaces of the massage roller 166.

A first support base in the form of a first supportive plate 161l supports a first end of massage roller 166 at handle 164l and a second support base in the form of a second supportive plate 161r supports a second end of massage roller 166 at a handle 164r. A bottom portion of supportive plate 161l includes feet 162l and 163l to stablize supportive plate 161l while a bottom portion of supportive plate 161r includes a first foot 162r and a second foot (not visible) to stabilize supportive plate 161r.

As shown by way of example in FIG. 16, massage roller 166 may have a small diameter similar to that of the embodiment described with reference to FIG. 15, while the height of supportive plates 161l and 161r is shorter than that of supportive plates 151l and 151r.

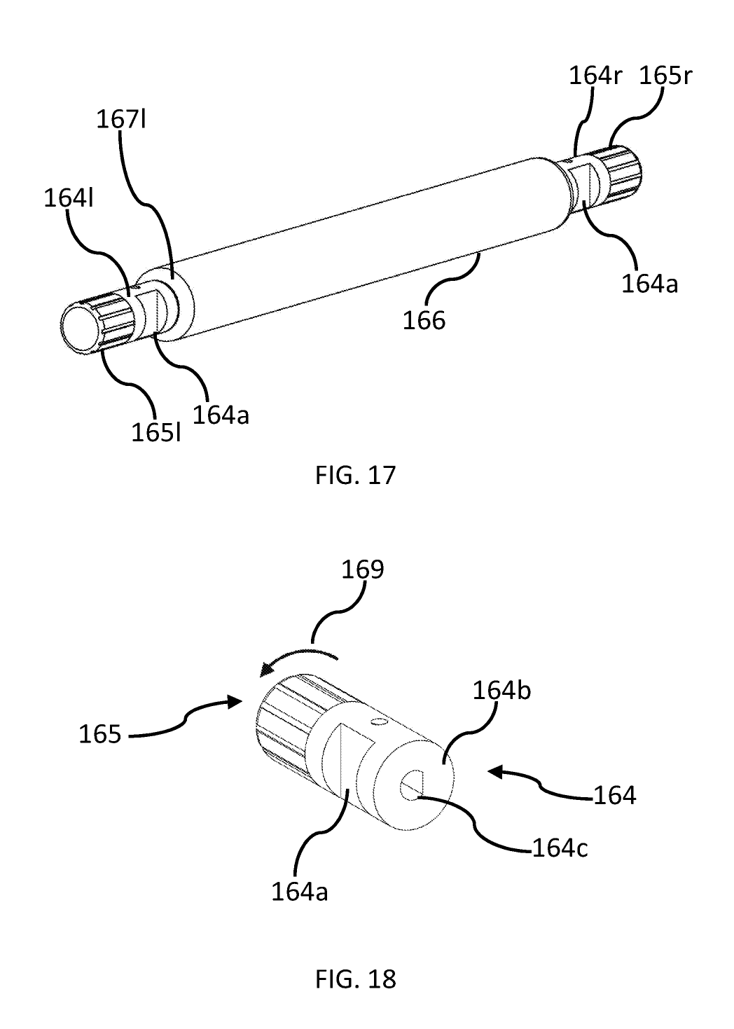

FIG. 17 is a perspective right side view of an example massage body assembly or massage roller 166 in accordance with the disclosure. Massage roller 166 is configured for rotatable mounting on an axle such as axle 168 such that first and second ends of the axle protrude from first 167l and second (not visible) end surfaces of massage roller 166. First 164l and second 164r handles are mounted to the first and second ends of the axle (not visible).

FIG. 18 is a perspective left view of an example handle assembly usable with one or more of the example massage roller systems 140, 150, 160 and 200 in accordance with the disclosure. Each handle 164 includes a knob 165 that, in response to twisting, adjusts pressure applied by the handle 164 to one of the first and second end surfaces of the massage roller to which it is coupled. Each handle includes at least one groove 164a configured to mate with a bearing surface of a first supportive plate of a massage roller systems such as 140, 150, 160 or 200. Grooves 164a restrict motion of handle 164 relative to the supportive plate upon which it rests along a first axis. In an example, the first axis along which the grooves restrict motion of the handles 164l and 164r is parallel to a longitudinal axis of the handles 164l and 164r of massage roller system 160 (FIG. 17). A lumen 164c is provided within a portion of handle 164 so as to have a curved cross-section portion and a flat cross-section portion whereby lumen 164c exhibits a D-shaped cross-section.

Additionally or alternatively, a disc may be provided between handle 164 and the massage roller with which the handle is coupled. In such an example, twisting of knob 165 forces the disc against an end of the massage roller to apply pressure to the end over a larger surface area.

FIG. 19 is a perspective left view of an example axle 168 in accordance with the disclosure. Axle 168, which may be usable as a component of, for example, massage roller systems 140, 150, 160 or 200 includes a first end having a facet 168a configured to mate with the flat cross-section portion of lumen 164c (FIG. 18) and external threads 168b configured to engage with internal threads of knob 165. Upon rotation of knob 165 in the direction of arrow 169 (FIG. 18), knob 165 and handle 164 advance along axle 168 in a direction towards a central portion of axle 168. This advance of knob 165 along axle 168 causes surface 164b to apply increasing pressure to an end surface such as 167l of massage roller 166. In response to the increasing pressure, massage roller 166, for example, offers increased resistance to rotation relative to axle 168. Similar rotation of knobs 1451 and/or 145r of massage roller system 140, knobs 155l and/or 155r of massage roller system 150, or knobs 1651 and/or 165r of massage roller system 160 yields similar increased resistance to rotation of massage roller 146, 156 or 166, respectively.

Upon rotation of knob 165 in a direction opposite to that of arrow 169, knob 165 and handle 164 advance along axle 168 in a direction away a central portion of axle 168. This advance of knob 165 along axle 168 causes surface 164b to apply decreasing pressure to an end surface such as 167l of massage roller 166. In response to the decreasing pressure, massage roller 166, for example, offers decreased resistance to rotation relative to axle 168.

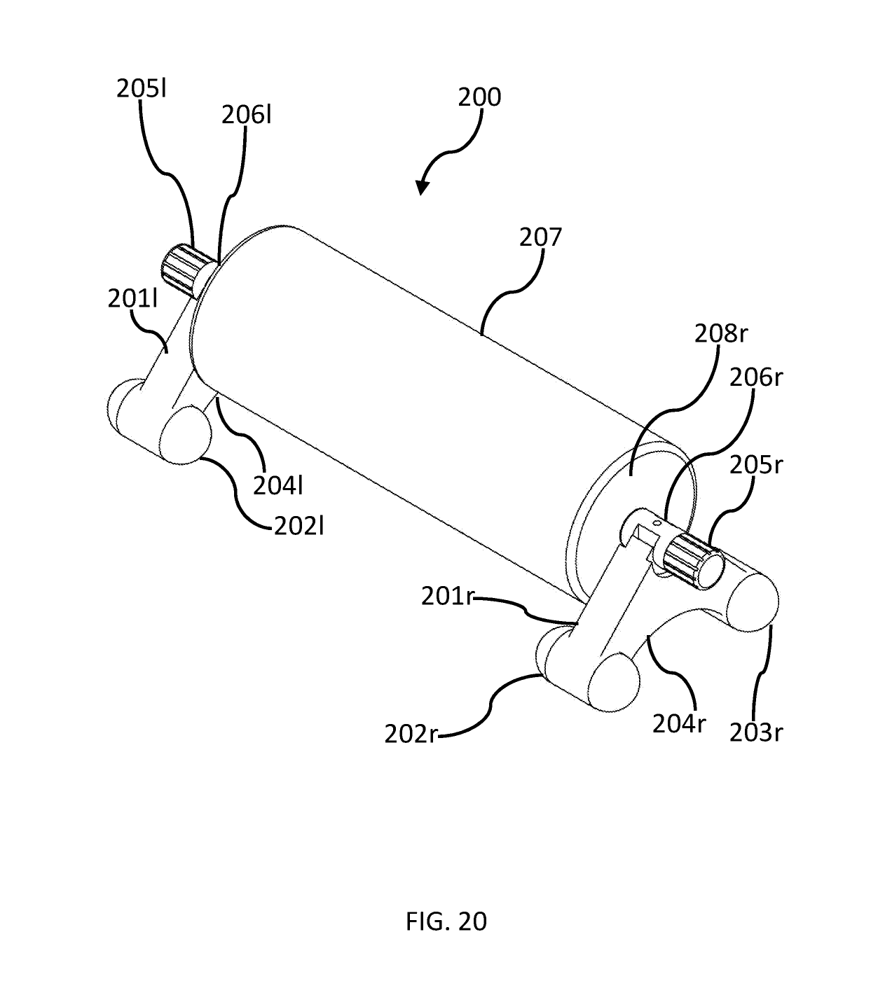

FIG. 20 is a perspective right side view of still another example massage roller system 200 in accordance with the disclosure. Massage system 200 includes an axle 168 (FIG. 19), a massage body assembly or massage roller 207 rotatably mounted on axle 168 such that first and second ends of the axle protrude from first (not visible) and second 208r end surfaces of massage roller 207. First 206l and second 206r handles are mounted to the first and second ends of the axle (not visible).

Upon rotation of knob 205l, knob 205r or both, knob 205l and handle 206l, knob 205r and handle 206r or both advance along axle 168 in a direction towards a central portion of axle 168. This advance causes surfaces of handle 206l, 206r or both to apply increasing pressure to end surfaces of massage roller 207. In response to the increasing pressure, massage roller 207, for example, offers increased resistance to rotation relative to axle 168.

A first support base in the form of a first supportive plate 201l supports a first end of massage roller 207 at handle 206l and a second support base in the form of a second supportive plate 201r supports a second end of massage roller 207 at a handle 206r. First supportive plate 201l further includes a bottom portion with feet 202l , 203l, and second supportive plate 201r further includes a bottom portion with feet 202r and 203r. Each of these feet may be rounded and have positive curvature protruding away from the first and second surfaces of the supportive plate with which they are coupled as shown by way of example in FIG. 20. The positive curvature may include but is not limited to spherical curvature.

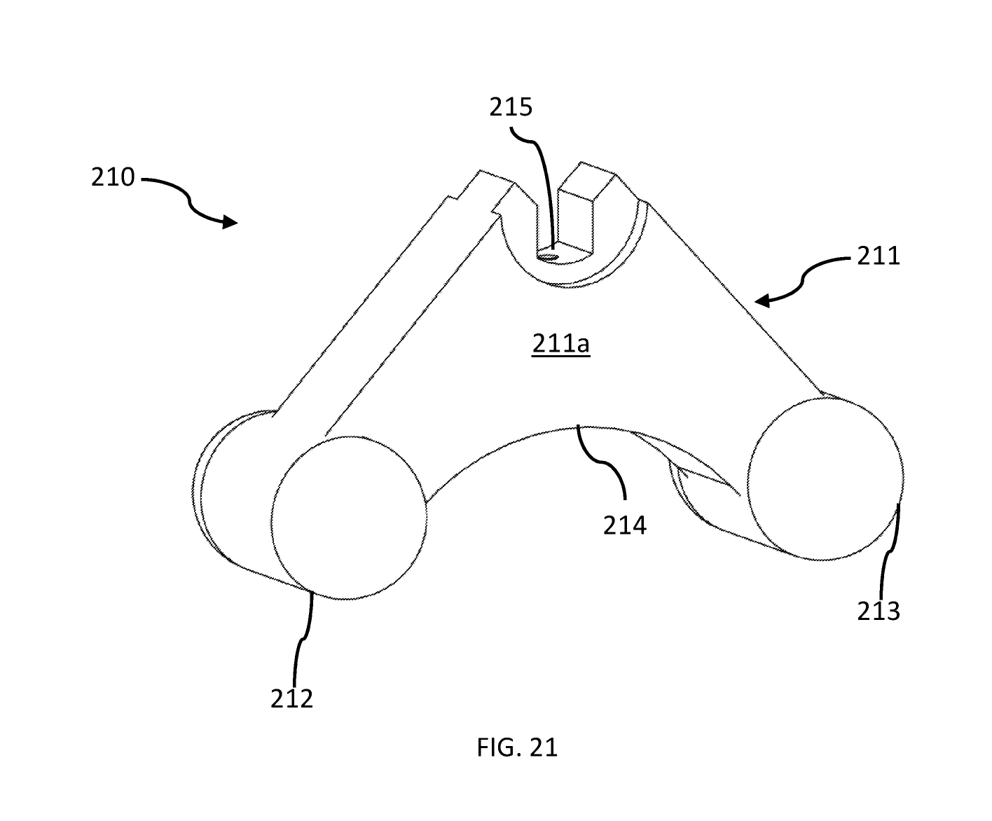

FIG. 21 is a perspective right view of an example support base 210 usable as part of disclosed massage roller systems, for example, as one of supportive plates 141l, 141r, 151l, 151r, 161l, 161r, 201l or 201r. The support base 210 may take the form of a first supportive plate 211 including a first surface 211a, a second surface (not visible behind surface 211a) spaced apart from first surface 211a, first 212 and second 213 feet extending away from both the first 211a and second surfaces and a first bearing surface 215 extending between the first 211a and second surfaces and configured for supporting a first of handles 144l, 144r, 145l, 154r, 164l, 164r, 206l or 206r.

Supportive plate 210 may include a first arch 214 extending towards the first bearing surface 215 and between the first 212 and second 213 feet of the first supportive plate 211. First arch 214 may be defined by a radius of curvature swept through a plane parallel with one or more of the first surface 211a of supportive plate 210 and the second surface of supportive plate 210.

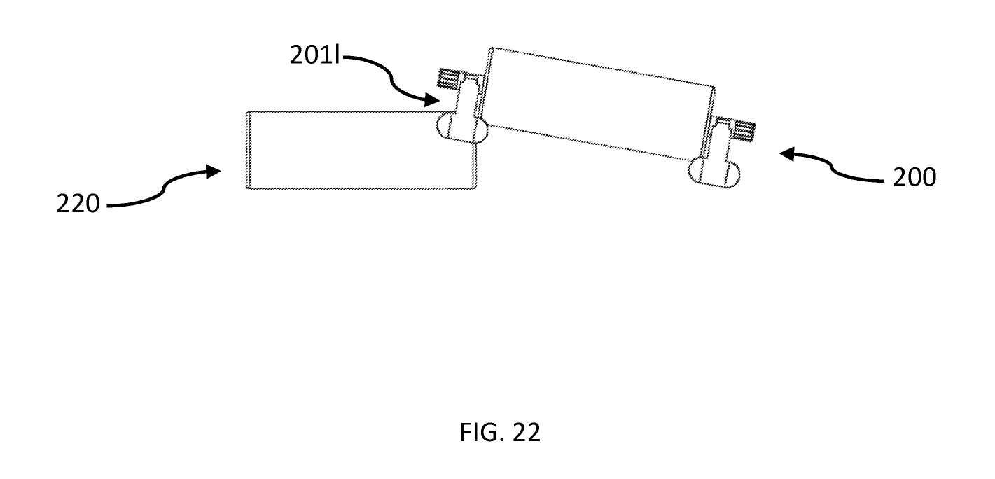

FIG. 22 is a front view of an example massage roller system in accordance with the disclosure having one end propped on a cylindrical object. For example, a massage roller system 200 (FIG. 20) is configured to mate with a cylindrical object 220 at, for example, the first 204l and second 204r arches of the supportive plates 201l and 201r, respectively. Example cylindrical objects include massage foam rollers.

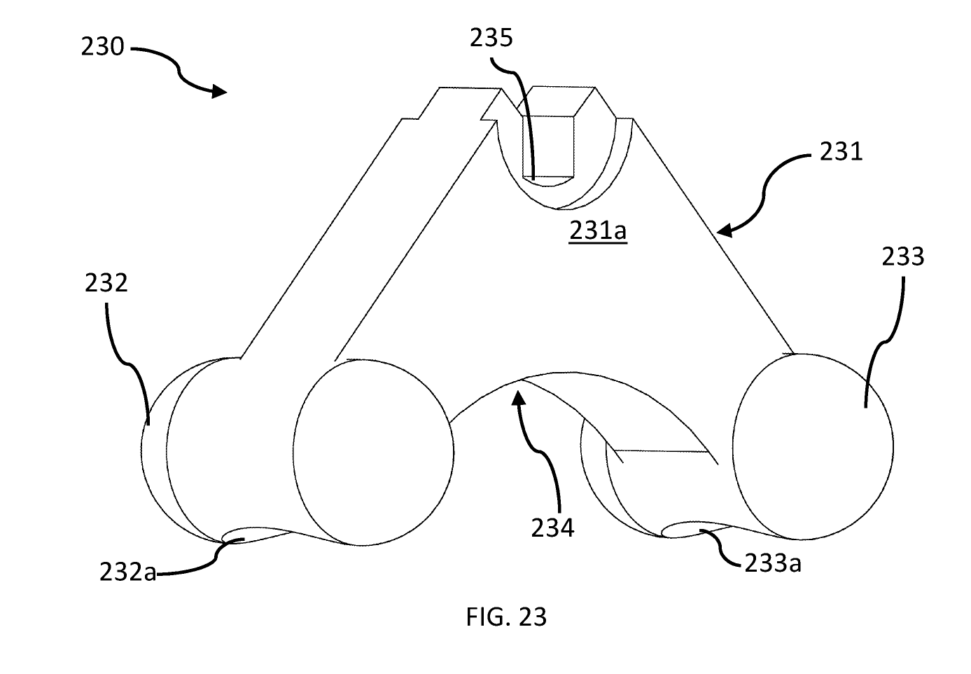

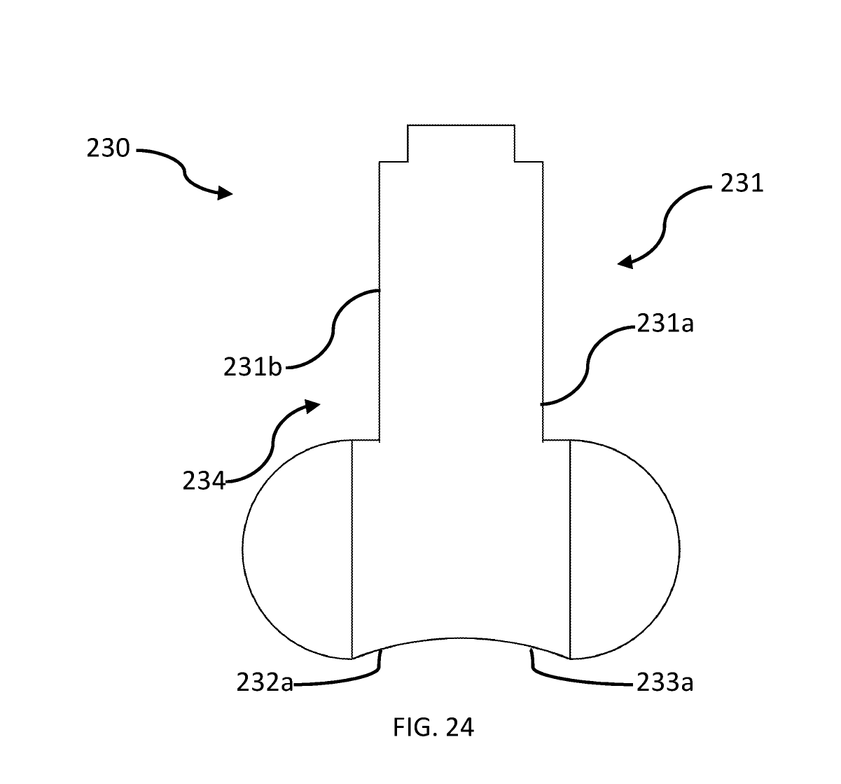

FIG. 23 is a perspective right view of an example support base 230 usable as part of disclosed massage roller systems, for example, as one of supportive plates 141l, 141r, 151l, 151r, 161l, 161r, 201l or 201r. The support base 230 may take the form of a first supportive plate 231 including a first surface 231a, a second surface 231b (FIG. 24) spaced apart from first surface 231a, first 232 and second 233 feet extending away from both the first 231a and second 231b surfaces and a first bearing surface 245 extending between the first 231a and second 231b surfaces and configured for supporting a first of handles 144l, 144r, 145l, 154r, 164l, 164r, 206l or 206r. Supportive plate 231 may include a first arch 234 extending towards the first bearing surface 245 and between the first 232 and second 233 feet of the first supportive plate 230. First arch 234 may be defined by a radius of curvature swept through a plane parallel with one or more of the first surface 231a of supportive plate 210, the second surface of supportive plate 210. Each of feet 232 and 233 may be rounded and have positive curvature protruding away from the first and second surfaces of the supportive plate with which they are coupled as shown by way of example in FIG. 23. The positive curvature may include but is not limited to spherical curvature.

FIG. 24 is a front view of example support base 230. Supportive plate 231, in addition to arch 234, includes, arches 232a and 233a each extending substantially between first surface 231a and the second surface and being defined by a radius of curvature swept through a plane substantially perpendicular to the plane through which the radius of curvature of first arch 234 is swept and also substantially perpendicular to one or more of the first surface 231a of supportive plate 231 and the second surface of supportive plate 231.

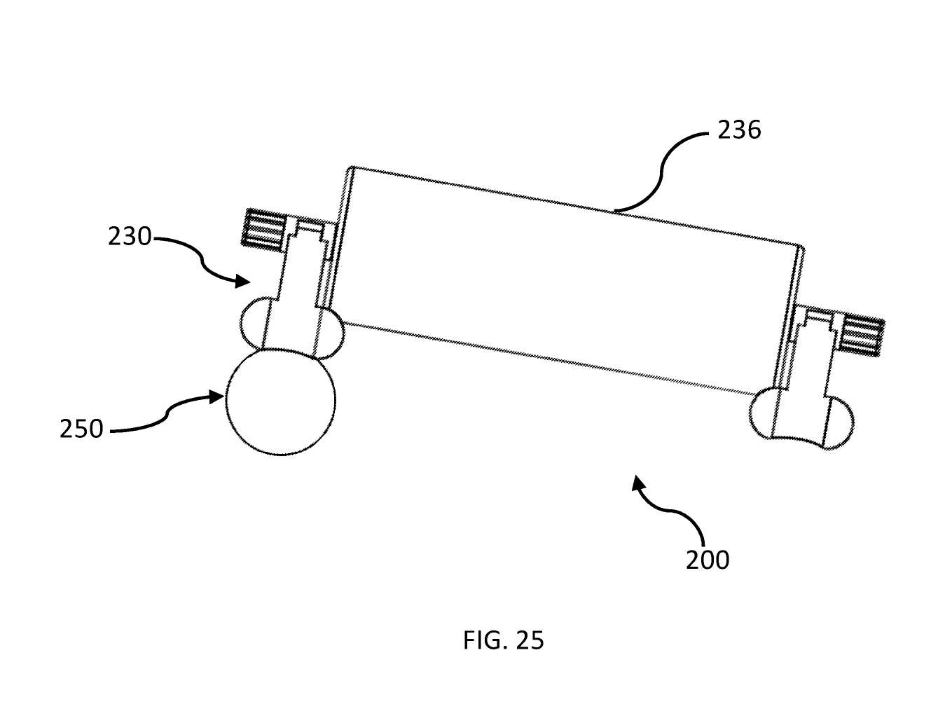

FIG. 25 is a front view of an example massage roller system in accordance with the disclosure having one end propped on a cylindrical object. For example, a massage roller system is configured to mate with a cylindrical object 250 at, for example, arches 232a and 233a of supportive plate 231. When arches 232a and 233a are resting on the curved surface of cylindrical object 250, massage roller 236 extends substantially perpendicular to cylindrical object 250. As mentioned above, example cylindrical objects include massage foam rollers.

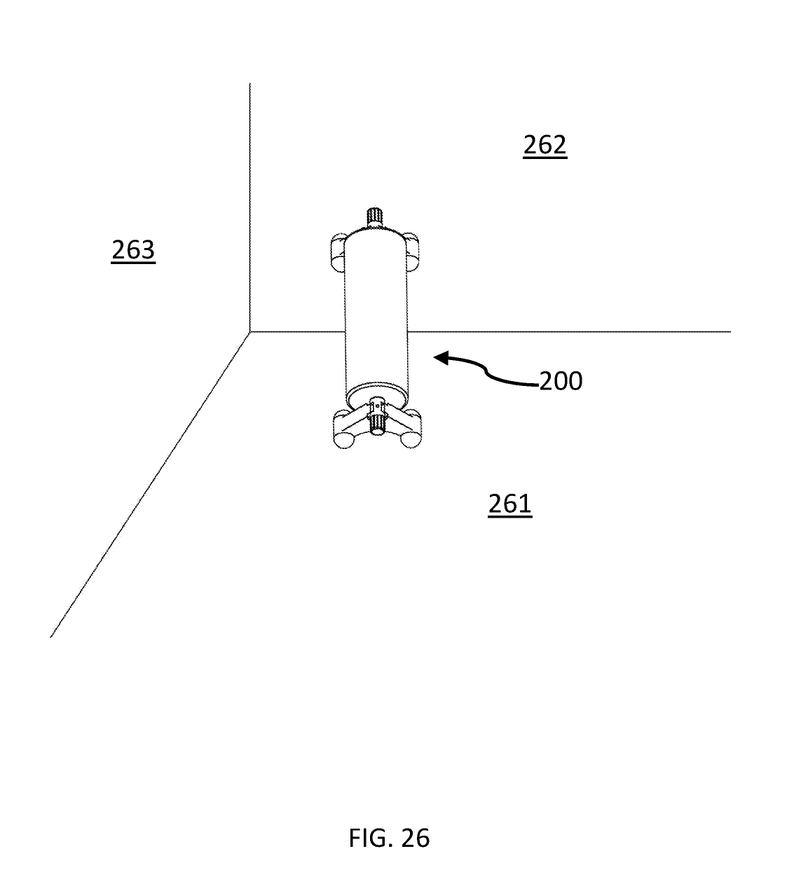

FIG. 26 is a side view of an example massage roller system in accordance with the disclosure having one end propped against a wall 262 while another end rests on support surface 261 which may be, for example, a floor or ground. When massage roller system 200 is propped against a wall 262, feet 202l and 203l contact support surface 261 while feet 202r and 203r contact wall 262. Alternatively, feet 202l and 203l may contact wall 262 while feet 202r and 203r contact support surface 261.

In either position, the massage roller of massage roller system 200 extends at an angle relative to both the support surface 261 and wall 262. In an example, wall 262 forms a 90-degree angle with support surface 261 and the massage roller forms a 45-degree angle with both support surface 261 and wall 262. In another example, the massage roller may form a 30-degree angle with support surface 261 while forming a 60-degree angle with wall 262. Massage roller system 200 may be positioned in any of a variety of ways so as to place the massage roller (for example any of massage rollers 146, 156, 166, 207, 236) at any of a variety of angles relative to support surface 261 or wall 262. It should be noted that massage roller system 200 may equivalently be propped against wall 263.

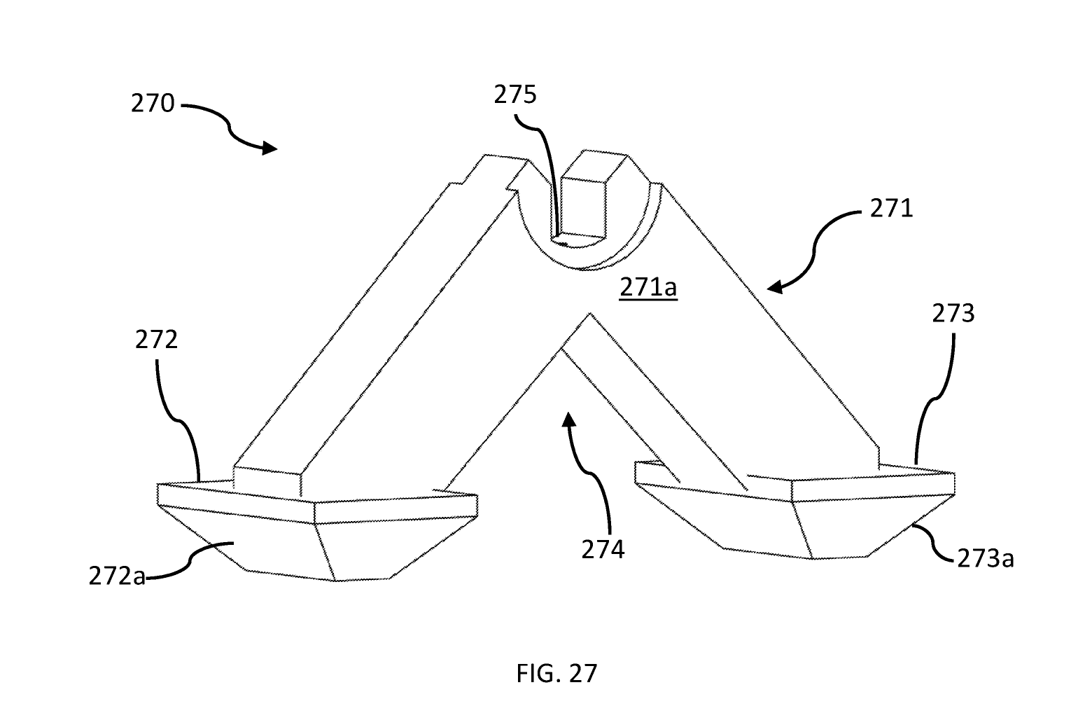

FIG. 27 is a perspective right view of an example support base 270 usable as part of disclosed massage roller systems, for example, as one of supportive plates 141l, 141r, 151l, 151r, 161l, 161r, 201l or 201r. Referring to FIG. 27, supportive plate 271 includes first 272 and second 273 feet separated by an arch 244. Foot 272 includes facets 272a while foot 273 includes facets 273a. When used as part of a disclosed massage roller system, first and second feet of a first supportive plate may include facets such as 272a and 273a configured to mate with a first support surface and the first and second feet of a second supportive plate may include facets such as 272a and 273a configured to mate with a second support surface angled relative to the first support surface while the facets 272a and 273a of the first foot are mated with the first support surface in a manner similar to that illustrated by way of example in FIG. 26. Facets 272a and 273a may form any of a variety of angles relative to the first and second surfaces of the supportive plates. In an example, the facets 272a and 273a form an angle of 45 degrees relative to the first 271a and second (not visible) surfaces of the supportive plate 271.

It should be noted that any of the example support bases and/or supportive plates described with reference to FIGS. 14-16 and 20-27 may be provided so as to exclude feet. For example, feet 272 and 273 may be excluded from supportive plate 271.

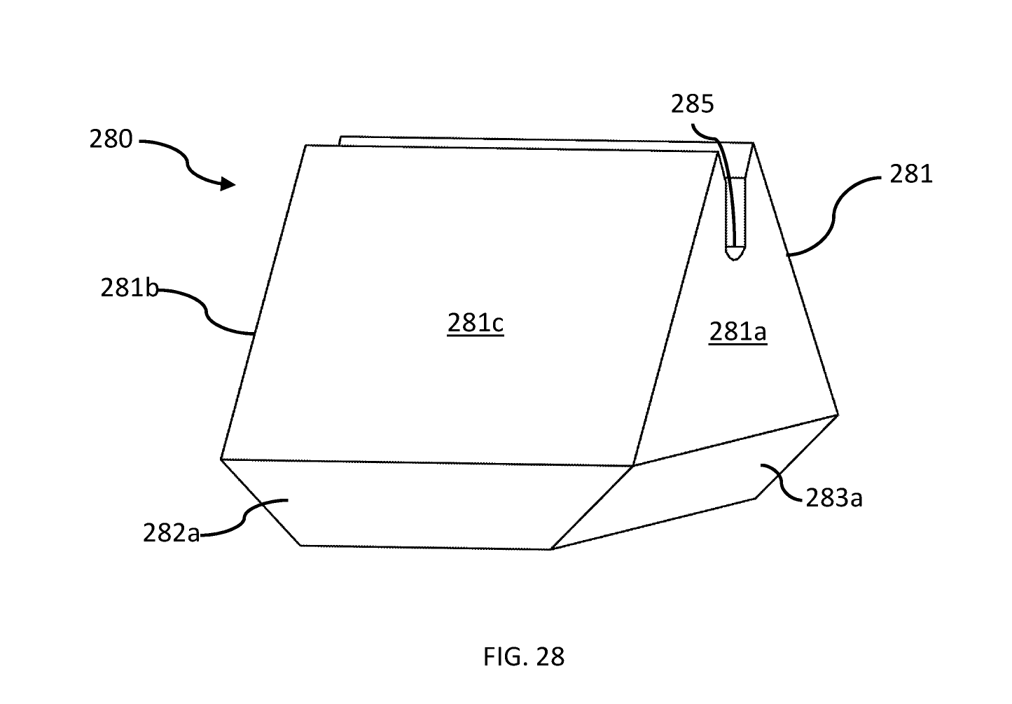

FIG. 28 is a perspective right view of an example support base 280 usable as part of disclosed massage roller systems, for example, as one of supportive plates 141l, 141r, 151l, 151r, 161l, 161r, 201l or 201r. Referring to FIG. 28, support base 280 may take the form of a first supportive plate 281 including a first surface 281a, a second surface 281b spaced apart from first surface 281a and a first bearing surface 285 extending between the first 281a and second 281b surfaces and configured for supporting a first of handles 144l, 144r, 145l, 154r, 164l, 164r, 206l or 206r.

First surface 281a includes a first facet 283a while second surface 281b includes a second facet (not visible) similar to first facet 283a. Furthermore, a third facet 282a extends between the first and second surfaces and a fourth facet is provided to the back side (not visible) of supportive plate 281. When used as part of a disclosed massage roller system, facets such as 282a and 283a are configured to mate with support surfaces in a manner similar to that illustrated by way of example in FIG. 26. The first and second facets may form any of a variety of angles relative to the first and second surfaces of the supportive plate. In an example, the first and second facets form an angle of 45 degrees relative to the first 281a and second 281b surfaces of the supportive plate 281. The third and fourth facets may form any of a variety of angles relative to front surface 281c and/or the back surface (not visible).

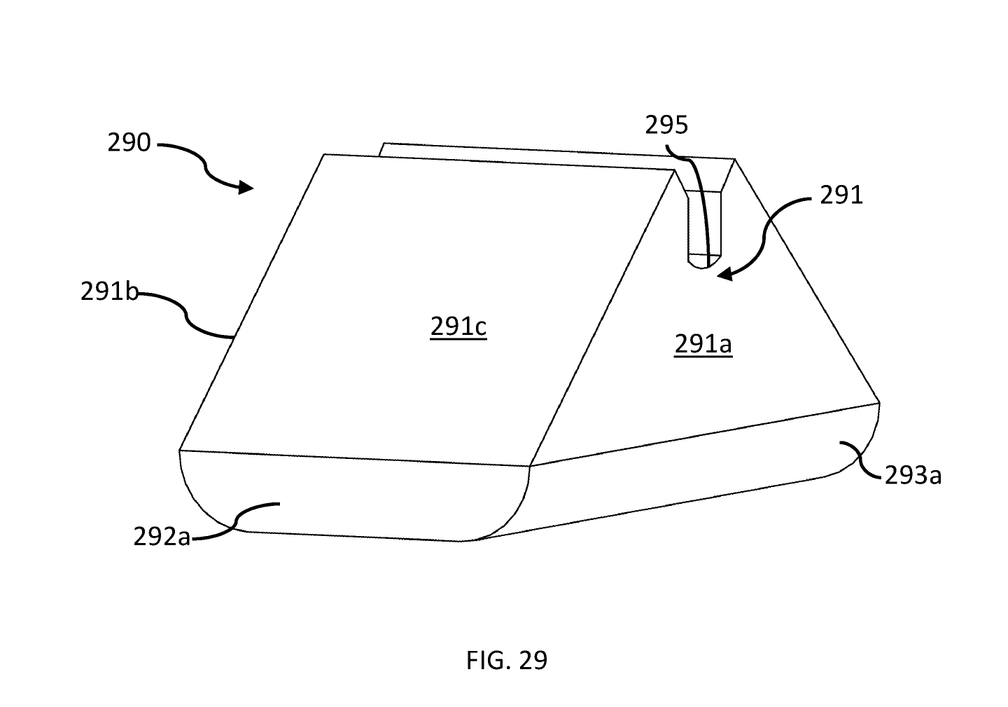

FIG. 29 is a perspective right view of an example support base 290 usable as part of disclosed massage roller systems, for example, as one of supportive plates 141l, 141r, 151l, 151r, 161l, 161r, 201l or 201r. Referring to FIG. 29, support base 290 may take the form of a first supportive plate 291 including a first surface 291a, a second surface 291b spaced apart from first surface 291a and a first bearing surface 295 extending between the first 291a and second 291b surfaces and configured for supporting a first of handles 144l, 144r, 145l, 154r, 164l, 164r, 206l or 206r.

When used as part of a disclosed massage roller system, first surface 291a and second surface 291b of a first supportive plate may include rounded edges such as 293a configured to mate with a first support surface and the first and second surfaces of a second supportive plate may include similar rounded edges configured to mate with a second support surface angled relative to the first support surface while the rounded edges of the first surface 291a are mated with the first support surface in a manner similar to that illustrated by way of example in FIG. 26. Furthermore, front surface 291c may include a rounded edge 292a and a back surface (not visible) may include a rounded edge similar to rounded edge 292a. Rounded edges 292a, 293a, etc. may express any of a variety of radii of curvature.

Although the description above contains many specificities, they should not be construed as limiting the scope of the embodiment but as merely providing illustrations of some of the presently preferred embodiments. For example, the sleeves can have other outside shapes, using rounded protrusions with spacing for the spine and other body parts, and be bumpy or ridged. The massage body can vary in size, shape and hardness thereby incorporating the characteristics of the sleeves. The support base can have other shapes and sizes necessary to accommodate varying sizes and shapes of massage bodies and sleeves or may be of sufficient height to facilitate a comfortable supine massage of the forearms and calves. The support base may also be configured with articulating joints or sides or axle supports of varying heights to offer an angled massage body and further customization possibilities.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A massage roller system, comprising:
an axle;
a massage roller rotatably mounted on the axle such that first and second ends of the axle protrude from first and second end surfaces of the massage roller;
first and second handles mounted to the first and second ends of the axle, each handle including a knob that, in response to twisting, adjusts pressure applied by the handle to one of the first and second end surfaces of the massage roller;
a first supportive plate including a first surface, a second surface spaced apart from the first surface, a first bearing surface extending between the first and second surfaces and supporting a first of the first and second handles and a first bottom portion opposite the first bearing surface; and
a second supportive plate including a first surface, a second surface spaced apart from the first surface and a second bearing surface extending between the first and second surfaces and supporting the second of the first and second handles and a second bottom portion opposite the second bearing surface.

2. The massage roller system as set forth in claim 1, wherein each of the first and second handles includes at least one groove configured to mate with at least one of the first bearing surface or the second bearing surface.

3. The massage roller system as set forth in claim 2, wherein each groove restricts motion of the handle relative to the supportive plate along a first axis.

4. The massage roller system as set forth in claim 1, wherein the first supportive plate further includes an first arch extending towards the first bearing surface from the first bottom portion of the first supportive plate and the second supportive plate further includes a second arch extending towards the second bearing surface from the second bottom portion of the second supportive plate.

5. The massage roller system as set forth in claim 1, wherein the first bearing surface further comprises an arch extending towards the first bottom portion and the second bearing surface further comprises an arch extending towards the second bottom portion.

6. The massage roller system as set forth in claim 1, wherein the first bottom portion of the first supportive plate include facets configured to mate with a first support surface and the second bottom portion of the second supportive plate include facets configured to mate with a second support surface angled relative to the first support surface while the facets of the first bottom portion of the first supportive plate are mated with the first support surface.

7. The massage roller system as set forth in claim 1, wherein the first bottom portion includes positive curvature protruding away from the first and second surface of the first supportive plate and the second bottom portion includes positive curvature protruding away from the first and second surfaces of the second supportive plate.

8. A massage roller system, comprising:
an axle;
a massage roller rotatably mounted on the axle such that first and second ends of the axle protrude from first and second end surfaces of the massage roller;
first and second handles mounted to the first and second ends of the axle;
a first supportive plate including a first surface, a second surface spaced apart from the first surface, a first bearing surface extending between the first and second surfaces and supporting a first of the first and second handles and a first bottom portion between the first and second surfaces opposite the first bearing surface;
wherein the first bottom portion of the first supportive plate includes facets configured to mate with a first support surface;
a second supportive plate including a first surface, a second surface spaced apart from the first surface, a second bearing surface extending between the first and second surfaces and supporting the second of the first and second handles and a second bottom portion between the first and second surfaces opposite the second bearing surface; and
wherein the second bottom portion of the second supportive plate includes facets configured to mate with a second support surface angled relative to the first support surface while the facets of the first bottom portion of the first supportive plate are mated with the first support surface.

9. The massage roller system as set forth in claim 8, wherein each of the first and second handles includes at least one groove configured to mate with at least one of the first bearing surface or the second bearing surface.

10. The massage roller system as set forth in claim 9, wherein each groove restricts motion of the handle relative to the supportive plate along a first axis.

11. The massage roller system as set forth in claim 8, wherein the first supportive plate further includes a first arch extending towards the first bearing surface from the first bottom portion of the first supportive plate and the second supportive plate further includes a second arch extending towards the second bearing surface from the second bottom portion of the second supportive plate.

12. The massage roller system as set forth in claim 8, wherein the first bearing surface further comprises an arch extending towards the first bottom portion and the second bearing surface further comprises an arch extending towards the second bottom portion.

13. The massage roller system as set forth in claim 8, wherein the facets are angled 45 degrees relative to the first and second surfaces of the first and second supportive plates.

14. The massage roller system as set forth in claim 8, wherein the first and second bottom portions include rounded edges.

15. A massage roller system, comprising:
an axle;
a massage roller rotatably mounted on the axle such that first and second ends of the axle protrude from first and second end surfaces of the massage roller;
first and second handles mounted to the first and second ends of the axle;
a first supportive plate including a first surface, a second surface spaced apart from the first surface, a first bearing surface extending between the first and second surfaces and supporting a first of the first and second handles and a first bottom portion between the first and second surfaces opposite the first bearing surface;
wherein the first supportive plate further includes an first arch extending towards the first bearing surface from the first bottom portion of the first supportive plate;
a second supportive plate including a first surface, a second surface spaced apart from the first surface, a second bearing surface extending between the first and second surfaces and supporting the second of the first and second handles and a second bottom portion between the first and second surfaces opposite the second bearing surface;
wherein the second supportive plate further includes a second arch extending towards the second bearing surface from the second bottom portion of the second plate.

16. The massage roller system as set forth in claim 15, wherein each of the first and second handles includes at least one groove configured to mate with at least one of the first bearing surface or the second bearing surface.

17. The massage roller system as set forth in claim 16, wherein each groove restricts motion of the handle relative to the supportive plate along a first axis.

18. The massage roller system as set forth in claim 15, wherein each of the first and second bearing surfaces further comprises an arch extending towards the first and second bottom portions.

19. The massage roller system as set forth in claim 15, wherein the first and second arches are defined by radii of curvature swept through a plane perpendicular to one or more of the first surface of the first supportive plate, the second surface of the first supportive plate, the first surface of the second supportive plate and the second surface of the second supportive plate.

20. The massage roller system as set forth in claim 15, wherein the first and second arches are configured to mate with a cylindrical object.

21. The massage roller system as set forth in claim 15, wherein the first and second arches are configured to mate with a massage roller.

22. The massage roller system as set forth in claim 15, the first and second bottom portions include rounded edges.
